(19) United States
(12) Patent Application Publication
(10) Pub. No.: US 2017/0049135 A1
(43) Pub. Date: Feb. 23, 2017

(54) Recovery Beer

(71) Applicant: Dennis Boline, San Antonio, TX (US)

(72) Inventor: Dennis Boline, San Antonio, TX (US)

(21) Appl. No.: 14/832,160

(22) Filed: Aug. 21, 2015

(51) Int. Cl. A23L 2/66; C12C 5/02; A23L 2/38

(52) U.S. Cl. CPC A23L 2/66; A23L 2/382; C12C 5/02; A23V 2002/00

(57) ABSTRACT

A process is provided for the preparation of a recovery beer or malt beverage that has enhanced nutrition in comparison to existing beer or malt beverages. The beverage comprises a beer or malt beverage that contains supplemental branch chain amino acids (BCAA). Such a beverage provides a healthier alternative to conventional beer or malt beverages, especially when consumed in post recreational, fitness or sport activities.

### BACKGROUND OF THE INVENTION

This invention relates to a new beer formulation and to a method of producing the same to industry standard. Intensive energy-consuming sport activities such as golf, skiing, tennis, fitness workouts, baseball, CrossFit, football and general athletics are increasingly becoming popular activities. The context in which these activities occur commonly includes post-recreational social gatherings, during which alcoholic beverages such as beer are often consumed. Hitherto, beer and malt beverages consumed at these events have been limited in nutritional needs associated with recreational activities; beer and malt beverages typically contents no branch chain amino acids (BCAA). Beer typically contains 13 g of carbohydrates, 1 g of protein, and 0 g branch chain amino acids (BCAA) per 12 fluid ounce servings.

Branch chain amino acids (BCAA) supplementation helps fight muscle fatigue, speeds up recovery, decrease the loss of other amino acids from muscle exercise and help the body absorb proteins. Intensive fitness activities stimulate the body needs to rebuild and strengthen muscle fibers, and replace the loss of other amino acids; hence branch chain amino acids (BCAA) supplementation is helpful following the fitness activities. Branch chain amino acids (BCAA) are scientifically proven to stimulate the building of protein in muscle and reduce muscle breakdown, enhancing exercise and athletic performance.

The present invention describes a beer/malt beverage that contains branch chain amino acids (BCAA) supplementation.

### SUMMARY OF THE INVENTION

This invention describes a new, improved recovery beer and a process for the preparation of the same. The recovery beer of the invention has the flavor, color and appearance of beer/malt beverages consumed during post recreational social settings, but contains substantially improved nutritional value. Typical beer beverages consumed during these settings are carbohydrate rich with little or no contents of branch chain amino acids. The recovery beverage of this invention has nutritionally beneficial supplements to provide higher levels of branch chain amino acids (BCAA).

The process described in this invention comprises a brewing process wherein barley malt grain is mashed in water, cereal grain adjuncts may or may not be added, amylase-type enzymes may or may not be added, the mash is clarified and boiled in a brew kettle, hops are added during the brew kettle boil or subsequently in the process, the extract or wort is clarified, cooled and aerated, yeast is added, yeast fermentation occurs, yeast is removed by filtration and centrifugation, beer aging and conditioning occurs, and branch chain amino acids are added.

### DETAILED DESCRIPTION OF THE INVENTION

The beverage described in this invention is composed of 92% to 99.5% water by volume, 0.45% to 8% ethyl alcohol by volume, 0.1 to 50 grams/liter branched chain amino acids.

The process for the production of the recovery beer described in this invention consists of a brewing process wherein barley malt grain is milled, mixed with hot water, cooked to convert complex carbohydrates into soluble fermentable sugars, the resultant mash is clarified and transferred to a brew kettle where it is boiled and, hops are added. The resultant extract or wort is clarified, cooled to 7 to 15 degrees C. and aerated, yeast is added, and yeast fermentation occurs for 3 to 10 days. Yeast is removed by settling, filtration and/or centrifugation, and beer lagering or maturation occurs. The beer is transferred to a finishing tank, where branch chain amino acids (BCAA) supplements are added, followed by carbonation. The Branch chain amino acids (BCAA) supplements are dissolved in filtered water prior to addition to the beer. Carbonation is conducted with 2 to 3 volumes of CO2 per volume of beer. Finally, the recovery beer is pasteurized or sterile filtered and packaged into bottles, cans or kegs.

In one embodiment of the invention, an all-malt beer/malt beverage is produced. In another embodiment of the invention, cereal grain adjuncts are cooked in water and added to the brew kettle, providing a different flavor and body than an all-malt recovery beer. In yet another embodiment of the invention, additional starch debranching enzymes such as amyloglucosidase or limit dextrinase (pullulanase) are added to the mash to increase to conversion of carbohydrates to fermentable sugars, providing a low calorie recovery beer product. Such starch debranching enzymes are commercially available.

This invention is further demonstrated by the following illustrative examples.

### EXAMPLE 1

composition:
266 liters filtered water
70 kg of pale malt
20 kg of Munich malt
10 kg of crystal malt
1.5 kg bittering pellet hops
2 kg aroma pellet hops
Branched chain amino acids, 236 g

Add the malt to 180 liters of 70 degree C. water and steep for 90 minutes at 67 degrees C. Sparge with 60 liters of 67 degrees C. water, transferring the entire mash to the brew kettle. Bring the extract in the brew kettle to a boil. Add the bittering hops. Boil for 45 minutes and add the aroma hops. Boil 15 minutes, cool and clarify the wort by using a settling tank or whirlpool tank. Aerate the wort while cooling to 20 degrees C. and transfer it to the fermentation tank. Pitch the wort with ale yeast, and ferment for 3 to 7 days. Transfer the beer to the maturation tank and mature the beer at 8 to 10 degrees C. for 3 to 4 weeks. Transfer the beer to the finishing tank; add 26 liters containing the branch chain amino acids (BCAA). Filter the beer through a plate and frame sheet filter and package into bottles, cans or kegs

The beverage has a 5% by volume alcohol content, providing a branch chain amino acids (BCAA) content of 1.5-5 gram per 12 fluid ounces.

### EXAMPLE II

composition:
266 liters filtered water
10 kg of crystal malt
50 kg of pale malt
35 kg of corn grits
2 kg bittering pellet hops
0.5 kg aroma pellet hops
Branched chain amino acids, 236 g
Ascorbic acid, 236 g

Add the malt to 180 liters of 65 degree C. water and steep for 60 minutes at 60 degrees C. Raise the temperature to 68 degrees C. and steep for 30 minutes. Sparge with 60 liters of 67 degrees C. water, transferring the entire mash to the brew kettle. Bring the extract in the brew kettle to a boil. Add the bittering hops. Boil for 45 minutes and add the aroma hops. Boil 15 minutes, cool and clarify the wort by using a settling tank or whirlpool tank. Aerate the wort while cooling to 20 degrees C. and transfer it to the fermentation tank. Pitch the wort with lager yeast, and ferment for 3 to 7 days. Transfer the beer to the maturation tank and mature the beer at 2 to 8 degrees C. for 3 to 4 weeks. Transfer the beer to the finishing tank; add 26 liters containing branch chain amino acids (BCAA) supplement. Filter the beer through a plate and frame sheet filter and package into bottles, cans or kegs

The beverage has a 4.5% by volume alcohol content, providing a branch chain amino acids (BCAA) content of 1.5-5 gram per 12 fluid ounces.

### EXAMPLE III

composition:
266 liters filtered water
10 kg of crystal malt
30 kg of pale malt
15 kg of rice solids
25 kg of corn grits
2 kg bittering pellet hops
0.5 kg aroma pellet hops
Ascorbic acid, 236 g
Calcium citrate, 1.86 kg

Add the malt to 180 liters of 65 degree C. water and steep for 450 minutes at 60 degrees C. Raise the temperature to 68 degrees C., add limit dextrinase or amyloglucosidase, and steep for 30 minutes. Sparge with 60 liters of 67 degrees C. water, transferring the entire mash to the brew kettle. Bring the extract in the brew kettle to a boil. Add the bittering hops. Boil for 45 minutes and add the aroma hops. Boil 15 minutes, cool and clarify the wort by using a settling tank or whirlpool tank. Aerate the wort while cooling to 20 degrees C. and transfer it to the fermentation tank. Pitch the wort with lager yeast, and ferment for 3 to 7 days. Transfer the beer to the maturation tank and mature the beer at 2 to 8 degrees C. for 3 to 4 weeks. Transfer the beer to the finishing tank; add 26 liters containing the protein and vitamin supplement. Filter the beer through a plate and frame sheet filter and package into bottles, cans or kegs.

The beverage has a 4.5% by volume alcohol content, providing an a branch chain amino acids (BCAA) content of 1.5-5 gram per 12 fluid ounces.

I claim:

1. A beer or malt beverage and process of making it, containing branch chain amino acids supplementation.

2. A beverage and process according to claim 1, wherein the beverage contains between 0.45% and 12% alcohol by volume.

3. A beverage and a process according to claim 1, wherein a starch source is mixed with a brewer's yeast and after fermentation, an amount of the branch chain amino acids supplementation is added at the final stage of the process

4. A beverage and process according to claim 1, wherein the branch chain amino acids supplementation added at the final stage of the process is from 0.25% to 5% by weight or no less than 0.01 g to no greater than 15 g.
